(19) United States
(12) Patent Application Publication
(10) Pub. No.: US 2007/0283981 A1
(43) Pub. Date: Dec. 13, 2007

(54) Method for cleaning storage tanks

(76) Inventor: Tracy E. Stewart, Destrehan, LA (US)

Correspondence Address: Browning Bushman P.C., Suite 1800, 5718 Westheimer, Houston, TX, 77057-5771, US

(21) Appl. No.: 11/449,285

(22) Filed: Jun. 8, 2006

(51) Int. Cl. B08B 7/04; B08B 9/00

(52) U.S. Cl. 134/10; 134/22.1

(57) ABSTRACT

A method of removing sludge from hydrocarbon storage tanks comprising introducing a hydrocarbon diluent into the storage tank to form a diluent/sludge mixture, circulating this mixture through the tank to obtain a blend of sludge and/or diluent, removing the bulk of the blend from the storage tank to leave a residuum, creating a non-combustible atmosphere in the storage tank, introducing an aqueous wash into the storage tank, the aqueous wash being at a temperature sufficient to heat the residuum to a temperature of not less than about 40° C., circulating the aqueous wash through the storage tank, separating hydrocarbons from a stream of residuum/aqueous wash removed from the storage tank to produce an aqueous wash recycle stream and introducing the recycle stream into the storage tank.

### BACKGROUND OF THE INVENTION

1. Field of the Invention

The present invention relates to the cleaning of storage tanks and, more particularly, to the removal of sludge from hydrocarbon storage tanks, particularly crude oil storage tanks.

2. Description of Prior Art

Over time, storage tanks used to store certain hydrocarbon products, e.g., crude oil, accumulate sludge in the bottom of the tank. The sludge which can accumulate to depths of 1 meter or more in large tanks used for crude oil storage pose a number of problems. It reduces tank capacity, clogs pumps and valves, poses environmental problems and can increase contamination of products moving through the tanks.

Depending on the nature of the hydrocarbon, e.g., crude oil, in the storage tank, the sludges can vary widely in their physical and chemical nature. For example, crude oil, as a natural product, differs widely in its compositional makeup and sludges produced from different crude oils differ accordingly. Crude oil sludges or sediments typically comprise organic or hydrocarbonaceous components such as asphaltines, paraffins, waxes and other high molecular weight hydrocarbons but can also comprise thickened crude oil fractions alone or in mixture with the organic components mentioned above. Additionally, the sludges usually contain varying amounts of inorganic components such as salts, oxides, rust, clay, etc.

To overcome the problems mentioned above with respect to accumulated sludges in storage tanks, it is necessary that the tanks be cleaned periodically, meaning that as much as possible of the sludge, regardless of its compositional makeup, be removed. Numerous methods and apparatuses for the removal of sludge from storage tanks have been proposed. Typically, most of these methods involve the use of hydrocarbon diluents or solvents alone or in combination with water washing. Typically the liquids employed in these techniques whether they are organic or aqueous in nature are pumped into the tank through high pressure jets to break up the sludge so that it can be pumped or otherwise easily removed from the tank.

### SUMMARY OF THE INVENTION

According to one aspect of the present invention, sludge is removed from a hydrocarbon storage tank by introducing a liquid hydrocarbon diluent/solvent into the storage tank to form a mixture with the sludge. The diluent/sludge mixture is circulated through the storage tank in order to obtain a blend of sludge and diluent. The bulk of the blend is removed from the storage tank leaving a residuum comprised of sludge diluent and blend. A non-combustible atmosphere is created in the storage tank and an aqueous wash is introduced into and circulated through the storage tank, the aqueous wash being at a temperature sufficient to heat the residuum to a temperature of not less than about 40° C. and form a residuum/aqueous wash mixture. A stream of the residue/aqueous wash mixture is removed from the storage tank and hydrocarbons are separated from the stream to produce a recycle stream of aqueous wash, the recycle stream being returned to the storage tank.

### BRIEF DESCRIPTION OF THE DRAWINGS

FIG. 1 is a schematic drawing of a typical storage tank of the floating roof variety showing a sludge deposit and a diluent layer, the floating roof of the storage tank, floating on the contents of the storage tank.

FIG. 2 is a view of the storage tank of FIG. 1 from which most of the sludge has been removed and showing a simplified flow diagram for removing the residuum from the storage tank.

### DETAILED DESCRIPTION OF PREFERRED EMBODIMENTS

While the present invention will be described with reference to the cleaning of storage tanks used to store crude oil, it should be understood that it is not so limited. The method of the present invention can be used to clean sludges or other sediments formed from other primarily liquid hydrocarbon material stored in storage tanks. Additionally, while the present invention will be described with reference to a storage tank of the floating roof variety, it is to be understood that it is not so limited and that it can be employed with storage tanks having fixed roofs.

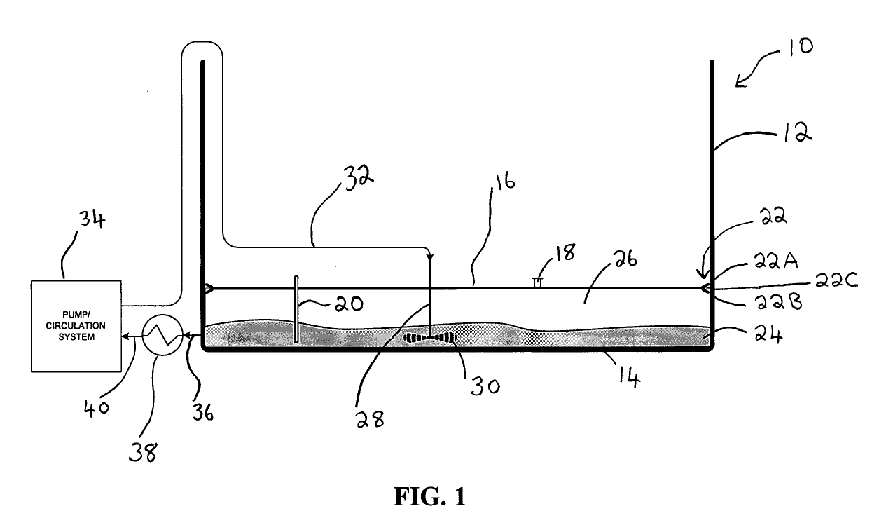

Referring first to FIG. 1, there is shown a typical floating roof storage tank 10 having a generally cylindrical side wall 12, a bottom wall 14 and a floating roof 60. As is typical of floating roof storage tanks, floating roof 16 is provided with roof vents 18 (only one of which is shown) and legs 20 (only one of which is shown). Floating roof 16 is provided on its periphery with an annularly extending sealing system 22 which engages side wall 12 and serves the dual purpose of preventing the egress of vapors from escaping between floating roof 16 and side wall 12 and the ingress of rain water into storage tank 10. It will be understood that when storage tank 10 is full, floating roof 16 would be disposed higher in storage tank 10 and, since it is floating on the contents of storage tank 10 it descends as the crude oil is removed from storage tank 10. As a practical matter, as the contents of storage tank 10 are removed, floating roof 16 will descend until legs 20 engage bottom wall 14. Floating roof seal systems such as sealing system 22, are well known and can comprise various forms such as mechanical seals, liquid seals, foam seals, secondary seals and double seals. There are a wide variety of such seals and their selection depends upon the type and condition of the floating roof storage tank in which they are used. In any event, most floating roof sealing systems also provide a wiping action such that as the floating roof descends into the tank as the contents are withdrawn, the seals of the sealing system wipe the peripheral side wall of the tank. Floating roof sealing system 22, as seen, has an upper seal portion 22A and a lower seal portion 22B, an annular seal area 22C being formed on the interior of side wall 12 between upper and lower portions 22A and 22B, respectively.

Contained in storage tank 10 is a sludge layer 24 and a hydrocarbon diluent layer 26, hydrocarbon diluent layer 26 being present in storage tank 10 to a level whereby floating roof 16 is floating on the surface of diluent layer 26 and roof legs 20 are displaced from bottom wall 14. Extending through floating roof 16 through suitable openings, e.g., leg sleeve opening, and into the contents of tank 10 below floating roof 16 is a jetting assembly comprising a lance/pipe 28 having a suitable nozzle (not shown) attached to the lower end thereof, the nozzle emitting a high pressure spray pattern 30 of a suitable liquid. Such jetting assemblies are well known to those skilled in the art and can provide spray patterns of a wide variety. Although not shown, it will be appreciated that there would generally be a plurality of lances 28 disposed in the interior of storage tank 10 so as to ensure that all of the sludge layer 24 can be subjected to the action of the liquid being jetted. As a practical matter, the lances 28 are lowered sequentially into the tank as they break up the sludge layer 24 until they reach a point where the spray patterns 30 are contacting the bottom wall 14 as well as the side wall 12. The lance 28 is attached to a line 32 which in turn is connected to a pump circulation system 34. In this regard, tank 10, as are most storage tanks, is provided with a suitable outlet near bottom wall 14 through which material in the tank may be withdrawn. Thus pumpable material is withdrawn through line 36, through the heat exchanger 38 (optionally) and line 40 by pump circulation system 34. Pump circulation system 34 can then force the pumpable material withdrawn from tank 10 through line 32 and the lances 28 forming part of the jetting assemblies.

In this stage of the method of the present invention and again referring to FIG. 1, the space in tank 10 between bottom wall 14 and floating roof 16 is filled with hydrocarbon diluent 26 and sludge layer 24 and floating roof 16 is floating, i.e., without legs 20 contacting bottom wall 14. To attain this state, it may be necessary to introduce a suitable diluent, e.g., crude oil, kerosene or other similar hydrocarbon, if there is not sufficient diluent 26 remaining in tank 10 when the cleaning is commenced. In any event, at this stage there is no vapor space in the tank 10 between floating roof 16 and bottom wall 14. Once pump circulation system 34 is started, it will begin to circulate mixture comprised of diluent 26 and sludge 24. As can also be seen and generally preferably, the mixture is heated via heat exchanger 38 although it will be appreciated that if heating is necessary internal heaters in tank 10 can be employed. In any event, as the mixture is circulated, the multiple jetting assemblies 28 disposed in tank 10 will force high pressure pumpable material back into vessel 10 with the net result that eventually, following the desired degree of circulation, a generally uniform blend of sludge 24 and diluent 26 will be formed. It will be understood that the blend will not necessarily be a total solution. In fact, generally the blend will be a solution of sludge 24 in diluent 26 plus undissolved solids, both organic and inorganic.

Once the blend of sludge 24 and diluent 26 has been formed, the bulk of it can be pumped from tank 10 using pump circulation system 34, a suitable valving system being employed to divert the output of pump circulation system 34 from line 32 into a line which can be sent for further processing. For example, in the case being described where tank 10 is for storage of crude oil in a tank farm adjacent a refinery, the blend can be returned to the refinery for further processing. Alternatively, if desired, a separate system can be used to pump and process the blend from the tank 10.

Once as much of the blend as possible is removed from tank 10, there will still remain a residuum which has to be removed. This residuum will generally comprise, in varying amounts, residual blend, residual sludge, residual diluent, and materials adhered to the side 12 and wall 14 of tank 10 which are not soluble or dispersible in diluent 26 or the blend and which require additional removal steps.

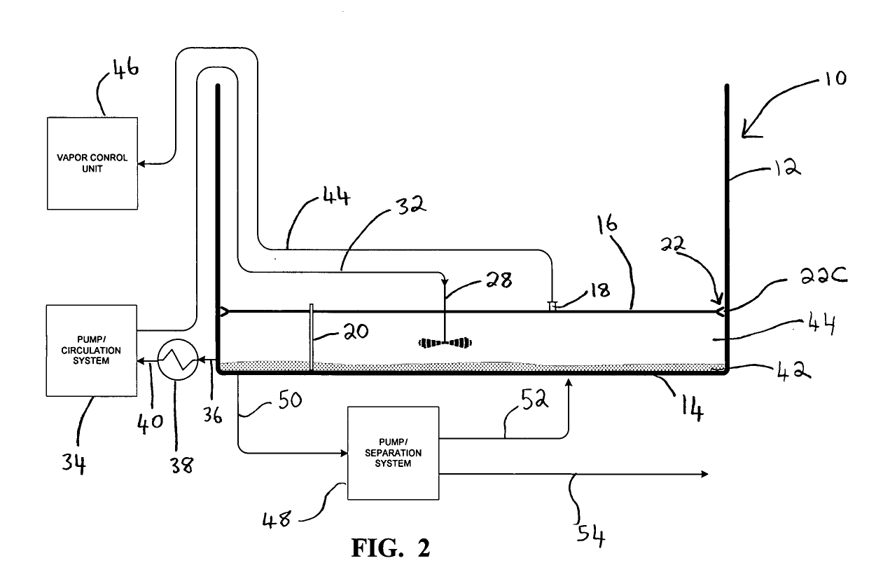

Referring now to FIG. 2, it can be seen that most of the contents of storage tank 10 has been removed leaving a residuum 42 and a vapor space 44. The roof vents, e.g., roof vent 18, have been provided with a capture line 44 which is connected to a vapor control unit 46, vapor control unit 46 comprising a vacuum pump, filters, carbon beds, thermal desorbers and other standard, necessary equipment to handle hydrocarbon vapors being removed from the vapor space 44 via roof vents 18 and capture line 44. As can also be seen, a pump/separation system 48 has an inlet line 50 connected to tank 10 and more specifically to the portion of tank 10 between bottom wall 14 and floating roof 16. Pump/separation system 48 can comprise a pump and a hydrocarbon/water separator, e.g., a decanting centrifuge or any other suitable oil or hydrocarbon/water separator. In pump/separation system 48, there is produced a water or aqueous phase, an oil or hydrocarbon phase and in certain conditions a solid phase. The aqueous phase forms a recycle stream which is pumped via line 52 back into storage tank 10 and, more specifically, to the space in tank 10 between floating roof 16 and bottom wall 14. The oil or hydrocarbon phase is removed from pump/separation system 48 via a line 54 and, since it is essentially hydrocarbon in nature, can be sent for further processing as described above with respect to the embodiment shown in FIG. 1, e.g., it can be returned to the refinery.

FIG. 2 depicts what can be referred to as an aqueous wash step wherein residuum 42 remaining in tank 10 is removed, in a manner described hereafter, preferably using a hot aqueous wash. As noted above, sealing system 22 which serves as both a seal and a wiper, forms a peripheral seal area 22C on the inside surface of wall 12. To ensure thorough tank cleaning, it is necessary that seal area 22C be cleaned. To this end, the seal portions 22A and 22B can be forced away from engagement with wall 12 and the area 22C cleaned with a aqueous wash, preferably a hot aqueous wash and optionally with cleaning agents, defoamers and the like. As seal area 22C is cleaned, the cleaning solution plus any hydrocarbon residue from seal area 22 falls into the space in tank 10 between bottom wall 14 and floating roof 16. Since seal area 22C can also be a source of trapped hydrocarbon vapors, provision can be made, as each section of seal area 22C is cleaned to capture any escaping vapors either by means of vapor control unit 46 or other suitable vapor control equipment.

In any event, once seal area 22C has been cleaned, there will remain in tank 10 the vapor in vapor space 44, residuum 42 and any aqueous wash and residue which has been washed from seal area 22C. It will be understood that the gases in vapor space 44 will be predominantly light hydrocarbons or at least sufficiently light hydrocarbons to create a combustible atmosphere. Accordingly, to create a non-combustible atmosphere, vapor control unit 46 can be activated to pump the gases in vapor space 44 out of tank 10 where they can be treated and/or disposed of in a suitable fashion. As vapor space 14 is being evacuated by vapor control unit 46, an inert gas, e.g., carbon dioxide, nitrogen, etc., can be introduced at a suitable location in tank 10 which is in open communication with vapor space 44 to create the non-combustible atmosphere. In practice, the gases being evacuated from vapor space 44 by vapor control unit 46 would be monitored to determine when a non-combustible atmosphere had been achieved, i.e., when the level of oxygen was sufficiently low enough to preclude a combustible atmosphere in vapor space 44. Once this inerting step, i.e., the creation of a non-combustible atmosphere in vapor space 44, has been accomplished, an aqueous wash can then be added to the tank 10 through a suitable opening in the roof 16, or through an opening in the side of the tank in communication with vapor space 44 or in any number of ways well known to those skilled in the art. The aqueous wash is introduced until it reaches a level which is above an outlet located near the bottom of tank 10 which can serve as a suction outlet for pump circulation system 34. At this point, circulation of the aqueous wash via pump circulation 34 can begin. It is to be noted that at this point, the legs 20 of floating roof 16 are resting on bottom wall 14, i.e., floating roof 16 is no longer floating on any liquid contents in tank 10. As aqueous wash is circulated through pump circulation system 34 it is also heated in a suitable fashion, e.g., with heat exchanger 38 until the temperature of the aqueous wash being circulated is raised sufficiently such that any contents of the tank, e.g., residuum 42, is raised to a temperature of at least 40° C. and preferably to 60° C. or higher. The combination of a heated aqueous wash and the high pressure jetting system provided by jetting assemblies 28 solubilizes water soluble components of the residuum, dislodges both organic and inorganic materials which may be adhered to the walls of tank 10, and breaks up the solid materials in tank 10 and slurries them so they can be more easily circulated by pump circulation system 34.

While circulation of the aqueous wash via pump circulation system 34 is being conducted, a separate stream of residuum and aqueous wash is being removed from tank 10 via line 50 and introduced into pump/separation system 48 wherein the aqueous wash is separated from any hydrocarbon components, a recycle stream of aqueous wash being returned to tank 10 via line 52, the hydrocarbons being removed via line 54 for processing in a suitable fashion. While the aqueous washing is being conducted, vapor control unit 46 can be continuously or intermittently operated to ensure that a non-combustible atmosphere is being maintained in vapor space 44.

Circulation via pump circulation system 34 and recycle via pump/separation system 48 is continued until it is determined that there is substantially no hydrocarbon, e.g., oil, being separated in pump/separation system 48. At this point the essentially hydrocarbon-free aqueous wash can then be sent to a suitable wastewater treatment system. Vapor control unit can be activated to now remove inert gas from vapor space 44 and fresh air introduced so as to provide a non-hazardous working environment for workers that enter tank 10 for inspection and to manually remove any deposits in tank 44 which have not been removed by the aqueous wash. Additionally, any pockets of remaining fluids can likewise be removed.

At such time as manned entry of the tank occurs, because of the efficiency of the inerting and aqueous wash steps, there will be negligible VOC content and in most cases hot work activities, e.g., welding, can be carried out in the tank 10 below floating roof 16. Indeed, as will be surmised from the above description of the method of the present invention, there is essentially no VOC emission at any point in the entire cleaning process. In this regard, vapor control unit 46 is generally in use during all phases of the cleaning method of the present invention.

As noted above, the liquid hydrocarbon diluent or solvent used to form the blend of the sludge can be a wide variety of liquids including crude oil, diesel, naptha, etc. The amount of diluent added to tank 10 can vary over wide ranges but generally will be present in an amount sufficient to fluidize, e.g., solubilize and/or slurry, the sludge. Again depending on the nature of the sludge, the volume/ratio of diluent or solvent to sludge will be in the range of 1:1 to 10:1. It is also within the scope of the present invention to sample the sludge to determine its approximate volume and compositional makeup and to select a diluent/solvent which is best suited to fluidize the sludge. Thus it may well be that mixtures of certain hydrocarbon diluents are more efficient than other solvents or mixtures. Since a primary component of typical crude oil sludges are paraffins and other such waxy solids, diluents which are efficient in dissolving paraffins are preferred. However, since the sludges also contain asphaltines, resins, etc., in addition to water and inorganic materials, the diluent is preferably capable of fluidizing and preferably solubilizing the maximum amount of hydrocarbon materials present. For example, it is known that paraffins are soluble in aliphatic solvents while asphaltines are more soluble in aromatic solvents. It is also preferred that the diluent have a high flash point to avoid hazardous solvent losses during the blending step.

As noted above, it is desirable in the method of the present invention that the seal area 22C on the inner surface of the peripheral wall 12 of the storage tank 10 be cleaned. This is most conveniently carried out by high pressure hot water washing, including the use of surfactants and other additives which would aid in dissolving the hydrocarbon residue on the seal area. Cleaning of the seal area can be accomplished while the aqueous wash is being added to the tank to the desired volume. However, creating a non-combustible atmosphere or inerting the vapor space in the tank is preferably not done until the seal area 22C has been cleaned albeit that addition of aqueous wash to the tank can be carried on while the inerting process is being carried out.

The purpose of the inerting process as mentioned above is to create a non-combustible atmosphere which is accomplished by reducing the oxygen content of the vapor space below the floating roof to less than about 5% by volume, preferably less than about 4% by volume. Furthermore, it is desirable to the extent possible, to remove hydrocarbon vapors present in the vapor space. As discussed, the vapor control unit, in addition to containing a vacuum pump, will generally contain other modules for capturing hydrocarbon and other toxic gases being removed from the vapor space in the tank. Thus, the vapor control unit can comprise filters, carbon beds, and other adsorbents which remove hydrocarbons. It is also possible that the vapor control unit can be tied back to the refinery and that the gases being removed from the vapor space in the tank be sent directly to the refinery. To ensure a non-combustible atmosphere, it is desirable that an inert gas such as carbon dioxide, nitrogen as well as other inert gases and mixtures thereof be introduced into the vapor space until it is determined that the gases being removed from the vapor space via the vapor control unit, have less than about 5% by volume oxygen and, preferably less than about 4% by volume oxygen.

In conducting the aqueous washing, once the blending of the sludge and preferably the inerting of the vapor space have been completed, aqueous wash is added to the tank to a level sufficient to maintain suction by the pump circulation system from an outlet in the tank. As is well known, storage tanks of the type under consideration generally have several such outlets disposed relatively close to the bottom of the tank. The aqueous wash can comprise simply heated water or water containing various additives such as dispersants, anti-foamers, emulsifiers, etc. In the description given above, the water of the aqueous wash is shown as being heated by means of heat exchanger 38. It will be recognized that any form of external heating of the aqueous wash be utilized, the sole requirement being that the aqueous wash can be heated to a temperature sufficient to raise the residuum in the tank to a temperature of at least 40° C. Maintaining the contents of the tank at or above this temperature maximizes fluidization of the residuum and solubilization of water soluble inorganic materials. It will be recognized that not all of the residuum will be soluble in the aqueous wash and that the material being recirculated by the pump circulation system as well as the recycle water from the pump/separation system may well be in the form of a slurry. Circulation of the aqueous wash continues until essentially no hydrocarbon is being separated in the pump/separation system. At this point, any solids remaining in the aqueous wash will be substantially inorganic in nature. Accordingly, this aqueous wash can be disposed of in typical wastewater treatment systems found in refineries, tank farms, etc.

The foregoing description and examples illustrate selected embodiments of the present invention. In light thereof, variations and modifications will be suggested to one skilled in the art, all of which are in the spirit and purview of this invention.

What is claimed is:

1. A method of removing sludge from hydrocarbon storage tanks comprising:
introducing a hydrocarbon liquid diluent into said storage tank to form a diluent/sludge mixture;
circulating said diluent/sludge mixture through said storage tank to obtain a blend of sludge and diluent;
removing the bulk of said blend from said storage tank, a residuum remaining in said storage tank;
creating a non-combustible atmosphere in said storage tank;
introducing an aqueous wash into said storage tank, said aqueous wash being at a temperature sufficient to heat said residuum to a temperature of not less than 40° C. to form a residuum/aqueous wash mixture;
circulating said aqueous wash through said storage tank;
separating any hydrocarbons from a stream of residuum/aqueous removed from said storage tank to produce an aqueous wash recycle stream; and
introducing said recycle stream into said storage tank.

2. The method of claim 1, wherein said hydrocarbon comprises crude oil.

3. The method of claim 1, wherein said hydrocarbon diluent comprises crude oil.

4. The method of claim 1, wherein said residuum comprises said blend, said sludge, and said diluent.

5. The method of claim 1, wherein said noncombustible atmosphere if created by pulling a vacuum in said storage tank and introducing an inert gas into said storage tank.

6. The method of claim 1, wherein said aqueous wash is heated by heat exchange.

7. The method of claim 1, wherein a hydrocarbon stream is separated from said residuum/aqueous wash mixture.

8. The method of claim 1, wherein said storage tank comprises a floating roof and said floating roof is floating on the level of said diluent/sludge mixture while said mixture is circulated through such storage tank.

9. The method of claim 8, wherein said storage tank comprises a sidewall and there is a seal between said floating roof and said side wall, a peripheral seal engagement area being formed on said side wall and said seal engagement area is cleaned prior to or while introducing said aqueous wash into said storage tank.

10. The method of claim 1, wherein said floating roof includes legs extending into said storage tank below said floating roof, said storage tank further having a bottom wall and said legs are resting on said bottom wall while the recycle stream of aqueous wash is circulated through said storage tank.
